(19) United States
(12) Patent Application Publication
(10) Pub. No.: US 2025/0163235 A1
(43) Pub. Date: May 22, 2025

(54) COATED POLYURETHANE FOAMS

(71) Applicants: Dow Global Technologies LLC, Midland, MI (US); Rohm and Haas Company, Collegeville, PA (US)

(72) Inventors: Yasmin N. Srivastava, Manvel, TX (US); Thomas C. Fitzgibbons, League City, TX (US); Praveenkumar Boopalachandran, Rosharon, TX (US); Daniel G. Abebe, Lake Jackson, TX (US); Tian Lan, Collegeville, PA (US); Yu Xindi, Paoli, PA (US)

(21) Appl. No.: 18/839,578

(22) PCT Filed: Feb. 28, 2023
(86) PCT No.: PCT/US2023/014010

§ 371 Date: Aug. 19, 2024

Related U.S. Application Data
(60) Provisional application No. 63/316,069, filed on Mar. 3, 2022.

(51) Int. Cl. C08J 9/36

(52) U.S. Cl. CPC C08J 9/365; C08J 2205/06; C08J 2375/04; C08J 2400/26; C08J 2491/06

(57) ABSTRACT

Articles useful for bedding and other comfort applications include a coated polyurethane foam. The coating includes an elastomeric polymer, a phase change material, a non-encapsulated wax and optionally a hydrophilic polymer. The coating provides desirable haptic properties, including a “cool touch” feature that creates a sensation of coolness when touched, and a highly smooth surface.

This invention relates to flexible polyurethane foams that are useful in cushioning applications, in particular so-called “comfort applications” such as bedding and pillows.

Polyurethane foams are used in very large quantities to make cushioning materials, for bedding and seating in particular. A growing segment of these polyurethane foams are the low resiliency, slow-recovering type, which are sometimes known as “viscoelastic” or “memory” foams. A problem with these foams is that they do not conduct heat very effectively. Heat given off by a user is trapped by the foam next to the user's body, which results in a localized temperature rise that is perceived by the user as being uncomfortable.

To combat this problem, so-called “gel technology” is used to impart a sense of coolness to the touch, which is important at point-of-sale. “Gel technology” involves using a phase change material to impart a “cool touch” feature to the foam. The phase change material (the “gels”) has a melting or phase transition temperature at about room temperature or slightly higher. It effectively absorbs body heat when touched, as the body heat causes the material to undergo its phase change. This causes the sensation of coolness when first touched.

The phase change material can be used as a surface topper or can be infused within the foams. When used as a surface topper, the phase change material provides “cool touch” but eventually begins to trap body heat due to the impermeability of the gel material. Large quantities of the phase change material are needed. Because the phase change material is encapsulated in a hard shell, it can cause the surface topper to become stiff and brittle.

WO 2017/210439 describes a polyurethane foam having a surface coating that contains an encapsulated phase change material. The coating is prepared from an aqueous emulsion that is applied to the foam and dried. This approach offers many advantages. It provides the desired “cool touch” feature in a coating layer that is thin, flexible and soft. Nonetheless, further improvements are desirable. In particular, better haptic properties such as smoothness are wanted, as the encapsulated phase change material often imparts some surface roughness. Coatings that contain large amounts of the encapsulated phase change material also tend to be harder than wanted.

This invention is in one aspect an article comprising a flexible polyurethane foam and a cured coating adhered to at least one surface of the flexible polyurethane foam, the cured coating comprising, by total weight of the cured coating (i) 33 to 60 weight percent of a solid, water-insoluble elastomeric polymer, (ii) 38 to 50 weight percent of embedded particles of an encapsulated phase change material, wherein the phase change material has a melting or glass transition temperature of 25 to 37° C., (iii) 0.5 to 5 weight percent of a non-encapsulated wax that has a melting temperature of at least 45° C., and (iv) 0 to 15 weight percent of a hydrophilic polymer that is a liquid at 23° C. and has a weight average molecular weight of 350 to 8000.

The coating provides the “cool touch” sensation that is wanted, while also exhibiting better haptic properties such as surface smoothness and softness. These properties render the article particularly useful for bedding and other comfort applications. Comfort applications include those in which during use the foam becomes exposed to the body heat of and/or water vapor evaporating from the body of a human user. The foam or an article containing the foam in such applications often supports at least a portion of the weight of a human user and becomes compressed during use due to the applied weight of the user. Examples of such comfort applications include pillows, mattress toppers, mattresses, comforters, furniture and/or automotive seating, quilting, insulated clothing and the like.

The invention in another aspect is a method of producing an article of the first aspect. The method comprises applying a coating composition composition to at least one surface of the flexible polyurethane foam and then curing the coating composition on the at least one surface of the flexible polyurethane foam, wherein the coating composition comprises A) one or more compounds that are liquid at 23° C. and have a boiling temperature at standard pressure of 40 to 100° C., and B) non-volatiles having a boiling temperature at standard pressure of greater than 100° C. dispersed and/or dissolved in A), wherein the non-volatiles comprise, by total weight of the non-volatiles, (i) 33 to 60 weight percent of a solid, water-insoluble elastomeric polymer, (ii) 38 to 50 weight percent of embedded particles of an encapsulated phase change material, wherein the phase change material has a melting or glass transition temperature of 25 to 37° C., (iii) 0.5 to 5 weight percent of a non-encapsulated wax that has a melting temperature of at least 45° C., and (iv) 0 to 15 weight percent of a hydrophilic polymer that is a liquid at 23° C. and has a weight average molecular weight of 350 to 8000 g/mol.

The flexible polyurethane foam (without the coating) may have, for example, a foam density of at least 24 kg/m³, at least 32 kg/m³, at least 36 kg/m³ or at least 40 kg/m³, as measured according to ASTM D3574-17. The foam density may be, for example, up to 120 kg/m³, up to 104 kg/m³, up to 92 kg/m³ or up to 80 kg/m³. The flexible polyurethane foam may exhibit an elongation to break of at least 50%, at least 75% or at least 100% as measured according to ASTM D3574-17.

The flexible polyurethane foam (without the coating) may exhibit a compression force deflection (CFD) value of 0.4 to 15.0 kPa, and more preferably 0.4 to 10 kPa, 0.4 to 5 kPa, 0.4 to 2.5 kPa or 0.4 to 1.5 kPa, at 40% compression, as measured according to ISO3386-1.

The flexible polyurethane foam (without the coating) may exhibit a resiliency of up to 70%, up to 60%, up to 50%, up to 25%, up to 20%, up to 15% or up to 10% on the ball rebound test of ASTM D3574-17.

The flexible polyurethane foam (without the coating) may exhibit a recovery time of at least one second or at least 2 seconds and up to 15 seconds, preferably up to 10 seconds. Recovery time for purposes of this invention is measured by compressing a 2.0-inch (5.08 cm) thick foam piece (4.0×4.0×2.0 inches, 10.16×10.16×5.08 cm) to 24% of its original thickness at room temperature, holding the foam at that compression for one minute and then releasing the compressive force. The time required after the compressive force is released for the foam to regain 90% of original foam thickness is the recovery time. Recovery time is conveniently measured using a viscoelastic foam-testing device such as a RESIMAT 150 device (with factory software) from Format Messtechnik GmbH.

The uncoated flexible polyurethane foam may exhibit an airflow of at least 0.8 L/s as measured according to ASTM D3574-17 test G. The airflow may be at least 1.2 L/s or at least 1.4 L/s and may be, for example, up to 8 L/s, up to 6 L/s or up to 4 L/s.

In a preferred embodiment, the uncoated flexible polyurethane foam is characterized in having a foam density of 32 to 92 kg/m³, a resiliency of at most 20% or at most 10%, and a recovery time of at least one second or at least two seconds and up to 10 seconds.

The uncoated flexible polyurethane foam in some embodiments exhibits a moisture wicking time of 5 seconds or less, preferably 4 seconds or less. Moisture wicking time is measured on 5.08×5.08×2.54 cm skinless samples that are dried to constant weight. 3 mL of room temperature (20-23° C.) water is slowly dropped onto the top surface of the foam sample from a pipette and the amount of time required for the foam to absorb the water is recorded as the wicking time.

Polyurethane foams having the foregoing characteristics can be prepared using general methods such as are described in, for example, in WO 2017/210439, U.S. Pat. Nos. 4,365,025, 6,479,433, 8,809,410, 9,814,187 and 9,840,575, US Published Patent Application Nos. 2004-0049980, 2006-0142529 and 2016-0115387, and PCT/US2018/052323, among many others.

The polyurethane foam may be in the form of an article having a volume (when uncompressed) of at least 200 cm³. Such an article may have a volume, for example, of at least 1 liter, at least 3 liters, or at least 5 liters. The volume may be, for example, up to 10,000 liters or up to 1000 liters. The polyurethane foam article may be, for example, a pillow, a mattress or a mattress topper, or component thereof. The article may be molded, i.e., prepared in a mold having an internal geometry the same as the external geometry of the article. The article may be a cut foam made by fabricating a larger foam body to the final dimensions and geometry of the article.

The cured coating includes non-volatile components, i.e., components that have a boiling temperature of greater than 100° C. at standard pressure. The non-volatile components of the cured coating include (i) a solid, water-insoluble elastomeric polymer, (ii) embedded particles of an encapsulated phase change material, wherein the phase change material has a melting or glass transition temperature of 25 to 37° C., (iii) a non-encapsulated wax that has a melting temperature of at least 45° C., and optionally but preferably a hydrophilic polymer that is a liquid at 23° C. and has a weight average molecular weight of 350 to 8000 g/mol.

All molecular weights herein are determined by gel permeation chromatography.

The elastomeric polymer (i) is a room temperature (23° C.) solid that is insoluble in water. The elastomeric polymer by itself (i.e., in the absence of the phase change material and ceramic particles) preferably has a glass transition temperature of no greater than 0° C. as measured by differential scanning calorimetry and an elongation to break of at least 50% (ASTM D412-16, method A). A polymer having those characteristics is considered for purposes of this invention to be elastomeric. The elastomeric polymer by itself may have a glass transition temperature) of no greater than −15° C., no greater than −25° C. or no greater than −40° C. Its elongation to break may be 100% or more.

Examples of suitable elastomeric polymers include natural rubber and synthetic polymers, including homopolymers and copolymers of conjugated dienes such as butadiene and isoprene; homopolymers and copolymers of acrylate monomers such as methyl acrylate, ethyl acrylate, hydroxyethylacryate, butyl acrylate and the like; homopolymers and copolymers of isobutylene; nitrile rubbers; polysulfide rubbers, silicone rubbers; homopolymers and copolymers of neoprene; polyurethane rubber and the like.

The encapsulated phase change material (ii) includes a phase change material that has a melting or glass transition temperature of 25 to 37° C., which phase change material is contained within a shell. The phase change material preferably has a melting temperature of 25 to 37° C. and more preferably has a melting temperature of 25 to 32° C. or 28 to 32° C. The encapsulated phase change material may exhibit a heat of fusion within the temperature range of 25 to 37° C. of at least 50 Joule/gram (J/g), at least 100 J/g or at least 150 J/g, as measured by differential scanning calorimetry. The heat of fusion may be as much as 300 J/g or more, but is more commonly up to 250 J/g or up to 200 J/g.

The weight of the phase change material, for purposes of this invention, includes the weight of the shell. The shell may constitute, for example, 5 to 25% of the total weight of the encapsulated phase change material, the phase change material itself constituting the remainder thereof, i.e., 75 to 95% by weight thereof.

The phase change material may be or contain, for example, a wax or mixture of waxes. The wax may be one or more of a natural or synthetic wax such as a polyethylene wax, bees wax, lanolin, carnauba wax, candelilla wax, ouricury wax, sugarcane wax, jojoba wax, epicuticular wax, coconut wax, petroleum wax or paraffin wax, provided that foregoing waxes that individually have melting temperatures below 25° C. or above 37° C. are used as a blend or mixture with one or more waxes such that the combination exhibits a melting temperature in the range of 25 to 37° C. If a mixture of waxes is present, one or more of the constituent waxes may by itself have a melting temperature below 25° C. or above 37° C. if the mixture has a melting temperature within that range.

The phase change material in some embodiments is an alkane having 14 to 30, especially 14 to 24 or 16 to 22 carbon atoms or a mixture of any two or more thereof. In a specific embodiment, the phase change material includes octadecane and/or eicosane.

The shell material may be, for example, a polymeric material that has a melting or decomposition temperature of at least 50° C. and preferably at least 100° C. Examples of useful shell materials include crosslinked thermoset resins such as crosslinked melamine-formaldehyde, crosslinked melamine, crosslinked resorcinol urea formaldehyde and gelatin.

The encapsulated phase change material is in the form of particles. The particles may have particle sizes of 100 nm to 100 μm as measured by microscopy. In some embodiments, the particles have particle sizes of at least 250 nm, at least 500 nm, at least 1 μm or at least 5 μm, and up to 75 μm or up to 50 μm.

Suitable methods for preparing the encapsulated phase change material are described, for example, in U.S. Pat. Nos. 10,221,323 and 10,005,059.

Suitable encapsulated phase change materials are available from Microtek Laboratories, Dayton, Ohio, US.

The non-encapsulated wax (iii) has a melting temperature of at least 45° C. The melting temperature may be at least 50° C. or at least 55° C. and may be, for example, up to 100° C., up to 85° C. or up to 70° C. The non-encapsulated wax may be or contain, for example, one or more of a natural or synthetic wax such as a polyethylene wax, bees wax, lanolin, carnauba wax, candelilla wax, ouricury wax, sugarcane wax, jojoba wax, epicuticular wax, coconut wax, petroleum wax, montan wax, or paraffin wax. If a mixture of non-encapsulated waxes is present, one or more of the constituent waxes may by itself have a melting termperature below 45° C. if the mixture of non-encapsulated waxes has a melting temperature of at least 45° C. Paraffin wax, carnauba wax or a mixture thereof are preferred non-encapsulated waxes.

The non-encapsulated wax is not encapsulated in a shell.

The hydrophilic polymer (iv) is a liquid at room temperature (23° C.) having a weight average molecular weight of 350 to 8,000 g/mol, especially 350 to 1200 or 350 to 800 g/mol. The hydrophilic polymer preferably is water-soluble. Such a hydrophilic polymer may contain at least 50 weight-% or at least 75 weight-% oxyethylene units, and may be, for example a homopolymer of ethylene oxide or a copolymer (random and/or block) of ethylene oxide and one or other alkylene oxides such as 1,2-propylene oxide. Especially preferred are poly (ethylene glycol) s having weight average molecular weights of 350 to 1200 g/mol, especially 350 to 800 g/mol.

The solid, water-insoluble elastomeric polymer (i) constitutes 33 to 60 weight percent of the total weight of the cured coating. In certain embodiments, the solid, water-insoluble elastomeric polymer constitutes at least 35% or at least 38% thereof and in some embodiments constitutes at most 55%, at most 52% or at most 48% thereof.

The embedded encapsulated phase change material (ii) constitutes 38 to 50 weight percent of the total weight of the cured coating. It may constitute at least 40% thereof, and in some embodiments constitutes up to 48% thereof.

The non-encapsulated wax (iii) constitutes 0.5 to 5 weight percent of the total weight of the cured coating. In some embodiments, the non-encapsulated wax (iii) constitutes at least 1% thereof, and in some embodiments constitutes up to 4% or up to 2% thereof.

The hydrophilic polymer (iv) may be absent. If present, it constitutes up to 15% of the total weight of the coating. In particular embodiments, the hydrophilic polymer (iv) constitutes at least 0.1% at least 1%, at least 5%, at least 8% or at least 10% of the total weight of the coating. The hydrophilic polymer (iv) may constitute up to 12.5% of the total weight of the coating.

Components (i), (ii), (iii) and (iv) together may constitute, for example, at least 90% or at least 95% of the total weight of the cured coating, and may constitute up to 100% or up to 99% thereof.

Other ingredients of the cured coating may include, for example, surfactants, rheology modifiers, colorants, preservatives, antioxidants and biocides.

The cured coating in some embodiments is produced by forming a coating composition containing the elastomeric polymer, encapsulated phase change material, non-encapsulated wax and hydrophilic polymer (if present), applying the emulsion or dispersion to a surface of the polyurethane foam and curing the emulsion to produce the cured coating. “Curing” is used in this context to simply mean that the coating composition is formed into a solid coating by any mechanism or combination of mechanisms as appropriate for the particular elastomeric polymer that is present. It is not necessary that any chemical reaction (such as, for example, polymerization, crosslinking or chain extension) take place during the curing step, although such a reaction may take place in some cases. Curing may simply involve drying the applied emulsion or dispersion to remove water and/or one or more other compounds that are liquid at room temperature (23° C.) and having a boiling temperature at standard pressure of 40 to 100° C. and produce a solid coating.

The coating composition preferably is in the form of an emulsion or dispersion that includes a continuous liquid phase into which components (i)-(iii) (and (iv), if present) are emulsified or dispersed. The continuous liquid phase contains water and/or one or more other compounds that are liquid at room temperature (23° C.) and have boiling temperatures at standard pressure of 40 to 100° C.; such materials may constitute, for example, 10 to 75%, preferably 20 to 60% or 40 to 55% of the total weight of the coating composition. The elastomeric polymer typically is dispersed in the continuous liquid phase in the form of particles or droplets, as is the non-encapsulated wax. The particles of the encapsulated phase change material also are dispersed therein. The hydrophilic polymer may be partially or entirely dissolved in the liquid phase. The emulsion preferably is aqueous, i.e., the continuous liquid phase includes water. Preferably the liquid phase of the coating composition contains no more than 10% by weight, especially no more than 5% or no more than 2%, of room temperature liquid organic compounds that have a boiling temperature at standard pressure of 40 to 100° C., based on the combined weight of such organic compounds and water.

When the coating composition is in the form of an emulsion or dispersion, the composition of the resulting coating conveniently is calculated from the proportions of the various ingredients in the coating composition after subtracting the weight of the water and/or one or more other compounds that are liquid at room temperature (23° C.) and having a boiling temperature at standard pressure of 40 to 100° C. In making such a calculation, all materials except the water and/or one or more other compounds that are liquid at room temperature (23° C.) and have a boiling temperature at standard pressure of 40 to 100° C. are considered as “non-volatiles” and are considered to remain with the coating after curing. The weight percentages of components (i), (ii), (iii) and (if present) (iv), are then calculated as their respective weights (on a dry basis, i.e., after removal of water and/or one or more other compounds that are liquid at room temperature (23° C.) and having a boiling temperature at standard pressure of 40 to 100° C. in which the respective component may be dispersed or emulsified) divided by the total weight of all non-volatiles.

The elastomeric polymer may be produced as an emulsion or dispersion in a liquid phase that includes water and/or one or more other compounds that are liquid at room temperature (23° C.) and having a boiling temperature at standard pressure of 40 to 100° C. Such an emulsion or dispersion may be produced in a emulsion polymerization process, in which one or more monomers are dissolved or dispersed into a liquid phase and subjected to polymerization conditions until the polymer chains precipitate and are converted to polymer particles or droplets dispersed in a liquid phase. The liquid phase of such an emulsion or dispersion can form some or all of the liquid phase of the coating composition used to coat the polyurethane foam in accordance with this invention.

Similarly, an emulsion or dispersion of the elastomeric polymer can be produced in a mechanical dispersion process in which molten elastomeric polymer is dispersed into such a liquid phase. The liquid phase used in such a mechanical dispersion process can form some or all of the liquid phase of the emulsion or dispersion used to coat the polyurethane foam in accordance with this invention.

In yet another suitable process, the elastomeric polymer may be ground or otherwise formed into small particles that are then dispersed in a liquid phase to form the emulsion or dispersion.

The non-encapsulated wax is advantageously provided in the form of a dispersion or emulsion in a liquid phase, the liquid phase containing water and/or one or more other compounds that are liquid at room temperature (23° C.) and having a boiling temperature at standard pressure of 40 to 100° C. One or more surfactants may be present in the dispersion or emulsion; the surfactant in such a case may be an anionic surfactant. Such a wax emulsion or dispersion may contain, for example, 10 to 50%, especially 20 to 40% or 25 to 35% of the wax, by weight. The liquid phase is preferably water, and the surfactant when present may constitute, for example, 0.1 to 10% of the weight of the wax dispersion or emulsion. The pH may of the dispersion or emulsion may be, for example, 8 to 14 to maintain an anionic surfactant in the salt form. An example of such a wax dispersion or emulsion is sold as AquaBead® 525E by Micro Powders, Inc. of Tarrytown, New York USA.

A coating composition in the preferred form of an emulsion and/or dispersion is conveniently formed by combining an emulsion or dispersion of the elastomeric polymer with the phase change particles, an emulsion or dispersion of the non-encapsulated wax, and the hydrophilic polymer (if present), to provide a coating composition in which components (i)-(iv) are present at proportions as indicated before.

Such a coating composition may include one or more optional materials, in addition to those already described.

Another useful optional material is one or more surfactants, which can perform one or more useful functions. Such a surfactant may function as a wetting agent, facilitating the dispersion of the particles of the phase change material and/or the ceramic particles into the remaining ingredients of the coating composition. A surfactant may function as a defoamer or deaerator, to reduce the entrainment of gases by the coating composition and reduce bubbles. Various silicone surfactants are useful for these purposes, as well as various non-silicone surfactants such as sulfate esters, sulfonate esters, phosphate esters, ethoxylates, fatty acid esters, amine oxides, sulfoxides and phosphine oxides. A surfactant may be nonionic, anionic, cationic or zwitterionic. One or more surfactants may constitute, for example, 0.1 to 5 weight-percent based on the total weight of the coating composition. Some or all of the surfactant may be introduced to the coating composition as part of an emulsion of the elastomeric polymer, as part of a dispersion or emulsion of the non-encapsulated wax, or with one or more other ingredients. Alternatively or in addition, some or all of the surfactant may be a separately added material. Any such surfactant is considered as a non-volatile component for purposes of this invention.

Other useful ingredients include various rheology modifiers such as various thickeners and thixotropic agents. Among these are fumed silica and various water-soluble or water-swellable polymers of acrylic acid that contain free acid groups or carboxylic acid salt groups (such as, for example, alkali metal, ammonium (NH₄), quaternary ammonium, or quaternary phosphonium carboxylic acid salts). Particularly useful rheology modifiers include aqueous emulsions of crosslinked acrylic acid polymers, such as are sold by DuPont under the trade designation Acrysol®. Specific examples are Acrysol® ASE-60 and Acrysol ASE-95. When present, such rheology modifiers may constitute, for example, 0.01 to 5 weight-percent, preferably 0.05 to 1 weight percent, of the coating composition. Any such rheology modifier is considered as a non-volatile component for purposes of this invention.

The coating composition is conveniently prepared by mixing the foregoing ingredients. When the elastomeric polymer is provided in the form of an emulsion or dispersion, it is convenient to mix the remaining ingredients into the emulsion or dispersion of the elastomeric polymer in any convenient order with mixing to produce a homogeneous dispersion.

A useful way of producing a coating composition of the invention is to charge a portion of the liquid phase to a vessel. The hydrophilic polymer, if used, is mixed with this portion of the liquid phase, in the absence of the elastomeric polymer and non-encapsulated wax. The elastomeric polymer, preferably in the form of an emulsion or dispersion, the encapsulated phase change material, the non-encapsulated wax (again, preferably in the form of a dispersion or emulsion) and other ingredients then can be added and mixed in any convenient order.

In a particular embodiment, the coating composition is produced by combining ingredients comprising (a) an aqueous emulsion of the elastomeric polymer, the aqueous emulsion containing 30 to 70% by weight of a liquid aqueous phase;

(b) the encapsulated phase change material;

(c) an aqueous dispersion or emulsion of the non-encapsulated wax, the dispersion or emulsion containing 50 to 80% by weight of a liquid aqueous phase; and

(d) optionally the hydrophilic polymer.

The coating composition can be applied to at least one external surface of a polyurethane foam. The coating method is not particularly critical. Rolling, brushing, spraying, immersion or other coating methods are suitable.

Enough of the coating composition preferably is applied that, after curing, a cured coating having a thickness of 100 μm to 10 mm is produced. The coating thickness is preferably at least 250 μm or at least 350 μm and up to 2,500 μm, up to 1500 μm or up to 1000 μm.

The coating composition is cured on the surface of the polyurethane foam. The curing method may depend somewhat on the particular elastomeric polymer and/or on the physical form of the coating composition. The curing of coating composition in the form of an emulsion includes at least a drying step of removing water and/or one or more other compounds that are liquid at room temperature (23° C.) and have a boiling temperature at standard pressure of 40 to 100° C., as may be present in the coating composition. Such a drying step can be performed at approximately room temperature, such as from 15 to 30° C., or at an elevated temperature such as greater than 30° C. up to 100° C. or more.

If curing includes a chemical reaction (such as, for example, polymerization, crosslinking or chain extension), conditions of the curing reaction, such as temperature, the presence of coreactants, catalysts, initiators, etc. not otherwise present in the coating composition are selected to facilitate the chemical reaction to complete the cure.

The coated article typically is characterized in having a highly smooth surface. Surface smoothness is conveniently determined using laser scanning microscopy (LSM) according to ISO 25178-2:2012. Using this technique, the coated article in various embodiments exhibits a maximum peak to valley distance (i.e., S_{z}, the sum of the maximum peak height value (Sₚ) and the largest valley depth value (Sᵥ)) of 200 μm less, such as 50 to 200 μm, 50 to 150 μm, 80 to 150 μm or 80 to 140 μm.

The coated foam in some embodiments exhibits a microtexture roughness value of at most 50, preferably 20 to 45; a microtexture coarseness value of at most 20, preferably 8 to 18; an adhesive tack value of at most 15, preferably 5 to 10; a thermal cooling value of at least 8, preferably 9 to 15; and a thermal persistence value of at least 8, preferably 10 to 15, all as measured using a BioTac® Toccare apparatus (Syntouch BioTac® Product Manual, V. 21, August 2018) at a temperature of 24 to 25° C. and a relative humidity of 40 to 50%. The coated foam in some embodiments exhibits a durometer harness of at most 15 on the 00 scale as measured according to ASTM D2240.

The following examples are provided to illustrate the invention, but are not intended to limit the scope thereof. All parts and percentages are by weight unless otherwise indicated.

The Deaerator is a polyether siloxane copolymer with fumed silica, sold as Tego Airex 904W by Evonik.

The Emulsion is an acrylic latex polymer emulsion with 55% solids by weight. The latex particles are an elastomeric polymer having a T_{g} of −50° C. It is available as Rhoplex 3166 from The Dow Chemical Company.

PEG is a polyethylene glycol having an average nominal hydroxyl functionality of 2 and a number average molecular weight of approximately 600 g/mole.

The Surfactant is available from The Dow Chemical Company under the trade name Tergitol® 15-S-40.

RM (rheology modifier) 1 is an aqueous emulsion containing cross-linked acrylate particles having acid groups. The solids content is 28%. When diluted with water and neutralized with a base (NH₄OH), this product acts as a thickener.

RM 2 is an aqueous emulsion containing cross-linked acrylate particles having acid groups. The solids content is 18%. When diluted with water and neutralized with a base (NH₄OH), this product acts as a thickener.

NH₄OH is a 28-30% ammonium hydroxide solution, for neutralizing RM 1 and/or RM 2.

PCM 1 is a microencapsulated paraffin wax having a particle size of 14-24 μm. The wax constitutes 85-90% of the weight of the material, a polymeric shell constituting the remainder of the weight of the product. The phase change material has a melting temperature of approximately 28° C. The product has an enthalpy of melting of 180-190 J/g. It is commercially available as Nextek 28D from Microtek Laboratories.

PCM 2 is a microencapsulated paraffin wax having a particle size of 15-30 μm. The wax constitutes 85-90% of the weight of the material, a polymeric shell constituting the remainder of the weight of the product. The phase change material has a melting temperature of approximately 32° C. The product has an enthalpy of melting of about 170 J/g. It is commercially available as Nextek 32D from Microtek Laboratories.

The NEW (non-encapsulated wax) emulsion is a 30% dispersion of paraffin and carnauba wax in water and an anionic surfactant, sold as AquaBead525E® by Micro Powders, Inc., Tarrytown, New York USA. The dispersion pH is 10-11.0. The wax phase has a melting temperature of 60° C.

Coating composition Examples 1-4 and Comparative Samples A-E are made from the ingredients listed in Table 1 by combining them and mixing them in a high-speed laboratory mixer to produce a homogeneous mixture.

TABLE 1

| | Parts By Weight | | | | | | | | |
|---|---|---|---|---|---|---|---|---|---|
| Ingredient | Ex. 1 | Ex. 2 | Ex. 3 | Ex. 4 | A* | B* | C* | D* | E* |
| Water | 24.37 | 19.34 | 19.39 | 30.48 | 26.67 | 32.86 | 46.73 | 5.89 | 45.89 |
| PEG | 6.07 | 6.07 | 6.07 | 0 | 6.07 | 6.07 | 6.07 | 6.07 | 6.07 |
| Deaerator | 0.19 | 0.19 | 0.19 | 0.19 | 0.19 | 0.19 | 0.19 | 0.19 | 0.19 |
| Emulsion | 42.12 | 42.14 | 42.12 | 43.12 | 43.12 | 42.12 | 42.12 | 60 | 20 |
| Surfactant | 0.73 | 0.73 | 0.73 | 0.73 | 0.73 | 0.73 | 0.73 | 0.73 | 0.73 |
| PCM1 | 21.51 | 26.00 | 21.51 | 21.51 | 21.51 | 15 | 0 | 21.51 | 21.51 |
| PCM2 | 1.46 | 2.00 | 1.46 | 1.46 | 1.46 | 0.50 | 0 | 1.46 | 1.46 |
| NEW | 2.27 | 2.27 | 7.25 | 2.27 | 0 | 2.27 | 2.27 | 2.27 | 2.27 |
| emulsion | | | | | | | | | |
| RM1 | 0.26 | 0.26 | 0.26 | 0.26 | 0.26 | 0.26 | 0.26 | 0.26 | 0.26 |
| RM2 | 1.02 | 1.02 | 1.02 | 1.02 | 1.02 | 1.02 | 1.02 | 1.02 | 1.02 |
| NaOH | 0.62 | 0.62 | 0.62 | 0.62 | 0.62 | 0.62 | 0.62 | 0.62 | 0.62 |
| Total Water, | 45 | 40 | 44 | 52 | 46.5 | 54 | 68 | 35 | 57 |
| % (approx.) | | | | | | | | | |
| Solids | 55 | 60 | 56 | 48 | 53.5 | 46 | 32 | 65 | 43 |
| (approx.) | | | | | | | | | |

*Not an example of the invention.

The coating compositions are used to produce coatings on polyurethane foams. A weighed amount of the coating composition is poured onto a top surface of a foam sample and spread using a roller brush to produce a smooth layer of uniform thickness with a surface area of about 316 cm². The applied coating is cured by heating the coated foam at 80° C. for 20 minutes, to produce a coating having a thickness of about 500 μm. The approximate composition of the cured coatings, as calculated from the composition of the coating composition, are as indicated in Table 2.

TABLE 2

| Cured | | | | | | | | | |
|---|---|---|---|---|---|---|---|---|---|
| Coating | | | | | | | | | |
| Compo- | Weight-% | | | | | | | | |
| nent | Ex. 1 | Ex. 2 | Ex. 3 | Ex. 4 | A* | B* | C* | D* | EX |
| Elasto- | 41.9 | 38.4 | 40.8 | 47.7 | 43.0 | 48.5 | 71.7 | 50.7 | 25.5 |
| meric | | | | | | | | | |
| Polymer | | | | | | | | | |
| (i) | | | | | | | | | |
| PCMs (ii) | 41.6 | 46.4 | 40.5 | 46.2 | 41.7 | 32.4 | 0 | 35.3 | 53.3 |
| NEW (iii) | 1.2 | 1.1 | 3.8 | 1.4 | 0 | 1.4 | 2.1 | 1.0 | 1.6 |
| PEG (iv) | 11.0 | 10.1 | 10.7 | 0 | 11.0 | 12.7 | 18.8 | 9.3 | 14.1 |
| Total | 95.8 | 96.0 | 95.8 | 95.3 | 95.7 | 95.0 | 92.6 | 96.3 | 94.5 |
| (i)-(iv) | | | | | | | | | |
| Others | 4.2 | 4.0 | 4.2 | 4.7 | 4.3 | 5.0 | 7.4 | 3.7 | 5.5 |

*Not an example of the invention.

Each of Examples 1-4 and Comparative Samples A-E are evaluated for surface roughness according to ISO 25178-2:2012. S_{z} values so obtained are as indicated in Table 3, smaller values indicating greater surface smoothness. In addition, each sample is subjectively evaluated for hand touch surface smoothness and cool touch feel, with relative ratings from 1 to 5 being assigned in each case. A higher smoothness rating indicates a smoother (less rough) feel and a higher cool touch rating indicates a greater cool feeling. Results of these evaluations are also as indicated in Table 3.

TABLE 3

| Parameter | Ex. 1 | Ex. 2 | Ex. 3 | Ex. 4 | A* | B* | C* | D* | E* |
|---|---|---|---|---|---|---|---|---|---|
| S_{z} | 100 | 127 | 136 | 140 | 201 | 260 | 250 | 90 | 393 |
| Hand touch | 4 | 3.5 | 3.5 | 3 | 3 | 3 | 3 | 4.5 | 2 |
| smoothness | | | | | | | | | |
| rating | | | | | | | | | |
| Cool touch | 4 | 4 | 4 | 4 | 4 | 3 | 1 | 2 | 4 |
| rating | | | | | | | | | |

*Not an example of the invention.

The effect of the non-encapsulated wax is seen by comparing the results obtained with Comparative Sample A, which contains no non-encapsuated wax, with those of Examples 1-4. All these samples contain similar amounts of the encapsulated phase change materials and all provide very good cool touch properties. However, Comparative Sample A is significantly less smooth than any of Examples 1-4 per the measured S_{z} values. This is further confirmed for Examples 1-3 by the subjective ratings, which in each of these cases is better than for Comparative Sample A. The inclusion of the poly (ethylene glycol) in Examples 1-3 is seen to lead to the best combination of S_{z}, hand touch smoothness and cool touch.

Comparative Samples B and C show the effect of removing some or all of the encapsulated phase change material. As expected, the cool touch properties are greatly diminished. Additionally, no benefit in surface smoothness is seen, the S_{z} values being significantly higher than for Examples 1-4.

Comparative Samples D and E show the effect of varying the relative amounts of the elastomeric polymer and encapsulated phase change material in the cured coating. A high proportion of the elastomeric polymer and low proportion of encapsulated phase change material (as in Comparative Sample D) leads to a very smooth surface, but the cool touch is poor. Very good cool touch is obtained when the amount of elastomeric polymer is small and the amount of encapsulated phase change material is high (Comparative Sample E), but surface smoothness is quite poor even though the non-encapsulated wax is present.

1. An article comprising a flexible polyurethane foam and a cured coating adhered to at least one surface of the flexible polyurethane foam, the cured coating comprising, by total weight of the cured coating (i) 33 to 60 weight percent of a solid, water-insoluble elastomeric polymer, (ii) 38 to 50 weight percent of embedded particles of an encapsulated phase change material, wherein the phase change materials has a melting or glass transition temperature of 25 to 37° C., (iii) 0.5 to 5 weight percent of a non-encapsulated wax that has a melting temperature of at least 45° C., and (iv) 0 to 15 weight percent of a hydrophilic polymer that is a liquid at 23° C. and has a weight average molecular weight of 350 to 8000 g/mol.

2. The article of claim 1 wherein the non-encapsulated wax one or more of paraffin wax and carnauba wax.

3. The article of claim 1 wherein the phase change material has a melting temperature of 25 to 37° C., exhibits a heat of fusion within the temperature range of 25 to 37° C. of at least 50 Joule/gram (J/g) as measured by differential scanning calorimetry, and comprises one or more of a polyethylene wax, bees wax, lanolin, carnauba wax, candelilla wax, ouricury wax, sugarcane wax, jojoba wax, epicuticular wax, coconut wax, petroleum wax or paraffin wax.

4. The article of claim 1 wherein the cured coating comprises 5 to 12 weight percent of (iv).

5. The article of claim 1 wherein the flexible polyurethane foam prior to coating has a density of 32 to 92 kg/m³ and exhibits a recovery time of 1 to 10 seconds and a resiliency of less than 20%.

6. A method of producing an article of claim 1 comprising applying a coating composition composition to at least one surface of the flexible polyurethane foam and then curing the coating composition on the at least one surface of the flexible polyurethane foam, wherein the coating composition comprises A) one or more compounds that are liquid at 23° C. and have a boiling temperature at standard pressure of 40 to 100° C., and B) non-volatiles having a boiling temperature at standard pressure of greater than 100° C. dispersed and/or dissolved in A), wherein the non-volatiles comprise, by total weight of the non-volatiles, (i) 33 to 60 weight percent of a solid, water-insoluble elastomeric polymer, (ii) 38 to 50 weight percent of embedded particles of an encapsulated phase change material, wherein the phase change material has a melting or glass transition temperature of 25 to 37° C., (iii) 0.5 to 5 weight percent of a non-encapsulated wax that has a melting temperature of at least 45° C., and (iv) 0 to 15 weight percent of a hydrophilic polymer that is a liquid at 23° C. and has a weight average molecular weight of 350 to 8000 g/mol.

7. A method of producing an article of claim 1 comprising applying a coating composition composition to at least one surface of the flexible polyurethane foam and then curing the coating composition, wherein the coating composition is produced by combining ingredients comprising
(a) an aqueous emulsion of the elastomeric polymer, the aqueous emulsion containing 30 to 70% by weight of a liquid aqueous phase;
(b) the encapsulated phase change material;
(c) an aqueous dispersion or emulsion of the non-encapsulated wax the dispersion or emulsion containing 50 to 80% by weight of a liquid aqueous phase and 20 to 50% by weight of the non-encapsulated wax; and optionally
(d) the hydrophilic polymer.

8. The method of claim 7 wherein the phase change material has a melting temperature of 25 to 37° C., exhibits a heat of fusion within the temperature range of 25 to 37° C. of at least 50 Joule/gram (JJ/g) as measured by differential scanning calorimetry, and comprises one or more of a natural or synthetic wax such as a polyethylene wax, bees wax, lanolin, carnauba wax, candelilla wax, ouricury wax, sugarcane wax, jojoba wax, epicuticular wax, coconut wax, petroleum wax or paraffin wax.

9. The method of claim 7 wherein the non-encapsulated wax is one or more of paraffin wax and carnauba wax.

10. The method of any of claim 7 wherein (c) is an aqueous dispersion or emulsion of paraffin and/or carnauba wax and the paraffin and/or carnauba wax constitutes 20 to 40% by weight of (c).
